(19) United States
(12) Patent Application Publication
(10) Pub. No.: US 2015/0088693 A1
(43) Pub. Date: Mar. 26, 2015

(54) METHOD FOR DISPLAYING AND NAVIGATING INTERNET SEARCH RESULTS

(71) Applicant: Michael Moore, Newport Beach, CA (US)

(72) Inventor: Michael Moore, Newport Beach, CA (US)

(21) Appl. No.: 14/331,139

(22) Filed: Jul. 14, 2014

Related U.S. Application Data
(60) Provisional application No. 61/960,721, filed on Sep. 25, 2013.

(51) Int. Cl. G06Q 30/06; G06F 17/30; H04L 29/08; G06F 3/0481

(52) U.S. Cl. CPC G06Q 30/0627; G06F 3/0481; G06F 17/30893; G06Q 30/0641; H04L 67/02
USPC 705/26.61; 705/27.1

(57) ABSTRACT

Systems and methods are used to efficiently and conveniently navigate, display, and complete interactions with on-line sources of information. A user interface may display information from separate and independent sources through two or more portals on a single web page. The two or more portals may be linked to the same search criteria such that the initially displayed windows originate from the same search criteria, but then may be independent so the portals are independently navigated. A user interface may display information from separate and independent sources so a user can efficiently and directly compare results based on the same search criteria. Accordingly, the user interface may calculate purchasing information such that products from different sources may be directly compared to account for a total cost or time to consummate the transaction. A user interface may also work in conjunction with mobile devices to save and execute searches and consummate transactions in an expedited manner.

### CROSS REFERENCE TO RELATED APPLICATIONS

This application claims benefit to U.S. Provisional Application No. 61/960,721, filed Sep. 25, 2013, which is incorporated by reference in its entirety herein.

### TECHNICAL FIELD

Embodiments of the present invention are directed at a web portal and collection of portlets that organizes web content.

### BACKGROUND

The internet permits a number of users to access a vast array of sources having an almost infinite amount of information. Because of the various web browsers, consumer resources, retailers, and outlets, a consumer is presented with a large amount of information in various forms with various levels of reliability. Therefore, if a consumer wants to be informed, much time is taken to navigate multiple sites, multiple pages, through multiple searches.

A web search engine is a software system located on one or more servers that is accessed over a network by a user that is designed to search for information on the internet. Search engines generally have a web crawler that follows the links on a web page and stores index databases for contents retrieved and analyzed from the HTML markup of the page.

When searching, a user generally has to individually navigate different pages. If multiple sources are compared or used, then the user must maintain multiple separate browser windows or tabs within the browser. If the user wants to view the information simultaneously, then the user must use the separate windows oriented to display on the same screen. However, searches and windows must be navigated individually to reach material from different sources on related topics. There is not a convenient or efficient way to relate, display, or compare the information from unrelated sources.

Moreover, especially when shopping, the information obtained from the different sources may not be directly compared by the consumer to provide a reasonable basis for making a purchasing decision. For example, on-line retailers may offer different delivery options such as to a store or residence, with different associated costs and shipment times. Physical retailers may offer direct pick up, but the consumer must drive to the location to retrieve the item. Therefore, a consumer must manipulate the observed values from the different sources to decide which purchase is best for them in terms of cost, delivery time, location, or other relevant factors.

When a user is online, the user generally also navigates completely unrelated sites or unrelated purposes. For example, a user may check an email account and/or social media to know what friends and family are doing. They may also check news, stocks, or other information sites to learn about the day's events. The user may also game, shop, post, work, and research, among a plethora of other tasks. Each of these activities is generally performed through different windows at different times. Therefore, the user may obtain alerts for activities associated with one or more of the interested actions through an inactive window, such as one that the user is not currently observing. The user may miss the alert until they navigate back to the associated window or open another session associated with the source of the alert. The present system of navigating the internet does not provide an adequate navigation of different sites or activities while permitting the user to stay alert to happenings on unrelated sites or other activity interfaces.

### BRIEF SUMMARY

Embodiments described herein are directed at an e-commerce web portal and collection of portlets that organizes web content on a single cloud-based webs ite platform, allowing seamless navigation and expedient retrieval of desired data and content in the most tune efficient and cost-effective way. Embodiments described herein include a virtual storefront, where users are given pricing options and availability of selected goods and services from various retail stores, outlets, distribution centers, and/or any other web available content on demand to assist in their decision making and automated search process. Therefore, embodiments described herein facilitates the efficient search and procurement of desirable items from multiple sources.

Systems and methods are used to efficiently and conveniently navigate, display, and complete interactions with on-line sources of information. A user interface may display information from separate and independent sources through two or more portals on a single web page. The two or more portals may be linked to the same search criteria such that the initially displayed windows originate from the same search criteria, but then may be independent so the portals are independently navigated. A user interface may display information from separate and independent sources so a user can efficiently and directly compare results based on the same search criteria. Accordingly, the user interface may calculate purchasing information such that products from different sources may be directly compared to account for a total cost or time to consummate the transaction. A user interface may also work in conjunction with mobile devices to save and execute searches and consummate transactions in an expedited manner.

### BRIEF DESCRIPTION OF THE DRAWINGS

FIG. 1A illustrates an exemplary display and input devices according to embodiments described herein.

FIG. 1B illustrates an exemplary user interface for presenting information to a user.

FIG. 1C illustrates exemplary categories that may be configured to display in a hierarchy for selection by a user.

FIG. 2 illustrates an exemplary user interface according to embodiments described herein.

FIG. 3 illustrates an exemplary user interface display in which a selected category was made by a user.

FIG. 4 illustrates an alternative presentation of the user interface for navigating to the same location of FIG. 3 from a different navigation pattern.

FIG. 5 illustrates a user interface search results screen in which the objects of the search are displayed to a user.

FIG. 6A illustrates a screen of the user interface in which the user has made a selection by providing input to the user interface of FIG. 5 through one or more input devices.

FIG. 6B illustrates exemplary select windows that may be manipulated so that as a window is navigated, it may be expanded to permit better viewing of its contents.

FIG. 6C illustrates an exemplary user interface in which search results are displayed in a manner to directly compare the associated cost of the individual transaction.

FIG. 7A illustrates an exemplary configurable user interface

FIG. 7B illustrates a user interface that may be configured by a user.

FIG. 8 illustrates an exemplary embodiment of a method comprising a recurring search.

FIG. 9 illustrates an exemplary user interface in which one or more windows are displayed that permits a user to actively navigate through multiple websites simultaneously.

FIG. 10 illustrates a flow chart of an exemplary application according to embodiments described herein.

FIG. 11 illustrates an exemplary bidding algorithm used to support the bidding platform.

FIG. 12 illustrates an exemplary system in which embodiments of the present invention may be applied.

FIG. 13 illustrates exemplary internal components of the servers and/or electronic devices including hardware and software.

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Systems and methods are described herein that may be used to efficiently and conveniently navigate, display, and complete interactions with on-line sources of information. A user interface may display information from separate and independent sources through two or more portals on a single web page. The two or more portals may be linked such that the respective images initially displayed on the separate portals originate from the same search criteria, but then may be independently navigated so the portals are then independent in their displays. The two or more portals may be linked uni-directionally such that navigation or manipulation of one portal alters the results of a second portal displaying information from a separate and independent source. However, the second portal may be navigated or manipulated without affecting the first portal. The two or more portals may be bi-directionally linked such that when either portal is navigated, the other portal is altered or navigated based on selections of the user within the other portal. The portals may be linked initially or under some conditions, but independent thereafter or under separate conditions. Therefore, a user may, for example, enter a single search criteria that returns results from separate and independent sources to display information related to the same search criteria. The two or more portals may thereafter be independently navigated to search for information about the single search criteria. However, if the user navigates away from information related to the search criteria, the information displayed on either of the two or more portals may be updated corresponding to search parameters as altered by the navigation of the user through the two or more portals.

The portals are linked when a user need only provide a single search criteria to the system, which is then used to navigate two or more of the linked portals simultaneously. The system may parse the search terms and translate or convert the search criteria into the appropriate search criteria for the respective portals to navigate to the respective pages associated with the portal. For example, the user may enter a search string in a text field, or provide search criteria through the selection of one or more categories and sub-categories as discussed herein. Once the criteria is entered, the respective portals are configured to display the desired websites or windows through the individual portal according to the search term. The portals may be programmed to be selected based on the search criteria, static selections of windows automatically selected by portal, or configurable by a user. If one portal is configured to display images of the search criteria, and another configured to provide third party information, such as reviews or a Wikipedia™ page, for example, then the search criteria can be sent to the respective locations without the user having to reenter or properly define the search criteria for the respective pages. In this case, the user would not have to separately indicate to view “images” or to see “Wikipedia”. The search terms, for example “luxury watch”, would be used to display the images of luxury watches in a first portal and the associated third party information page in another portal.

A user interface may display information from separate and independent sources so a user can efficiently and directly compare results based on the same search criteria. Accordingly, the user interface may calculate purchasing information such that products from different sources may be directly compared to account for a total cost or time to consummate the transaction. The user interface may permit a user to research products from different sources and then directly make a purchasing decision based on the calculated purchasing information. For example, the prices associated with the displayed results may be calculated or modified based on the shipping costs to receive a product, gas, or delivery costs to obtain the object. Similarly, other purchasing information relevant to the user may similarly be determined. For example, the time to acquire a product may include the time to drive to a location, the time to ship or have the object delivered, etc.

A user interface may also work in conjunction with mobile devices to save and execute searches and consummate transactions in an expedited manner. Therefore, a user may conveniently and efficiently enter in search criteria in a user interface easy to traverse and interact with. The search may then be executed at the convenience of the user by using one or more quick set features such as text, word, button combination, voice input, etc. on a mobile device to receive their results quickly, efficiently, and timely. Results of the search may be displayed to the user and options presented to the user for immediate transactions. For example, if a product was searched, the user may directly purchase the product. If a service was searched, a reservation or other typical action with respect to that service may be completed. The user interface may permit one touch or some method to quickly consummate a transaction without the delay of having to navigate to the retailer's site, enter in personal information, confirm the transaction, etc. Instead, through direct interaction of the user's accounts, paypal, other payment options, the user interface may exchange with the retailers site to complete the transaction with minimal steps to the user.

Although embodiments of the invention may be described and illustrated herein in terms of shopping and purchasing items over the internet, it should be understood that embodiments of this invention are not so limited, but are additionally applicable to providing an efficient and convenient interface to a user for presenting, navigating, and organizing information and data from different unrelated sources. Furthermore, although embodiments of the invention may be described and illustrated herein in terms of presenting information and data, it is understood to encompass any presentation to a user including output and/or input to/from the user, such as games, websites, applications, streaming music or video, social media, chat/postings, news feeds, stock updates, etc.

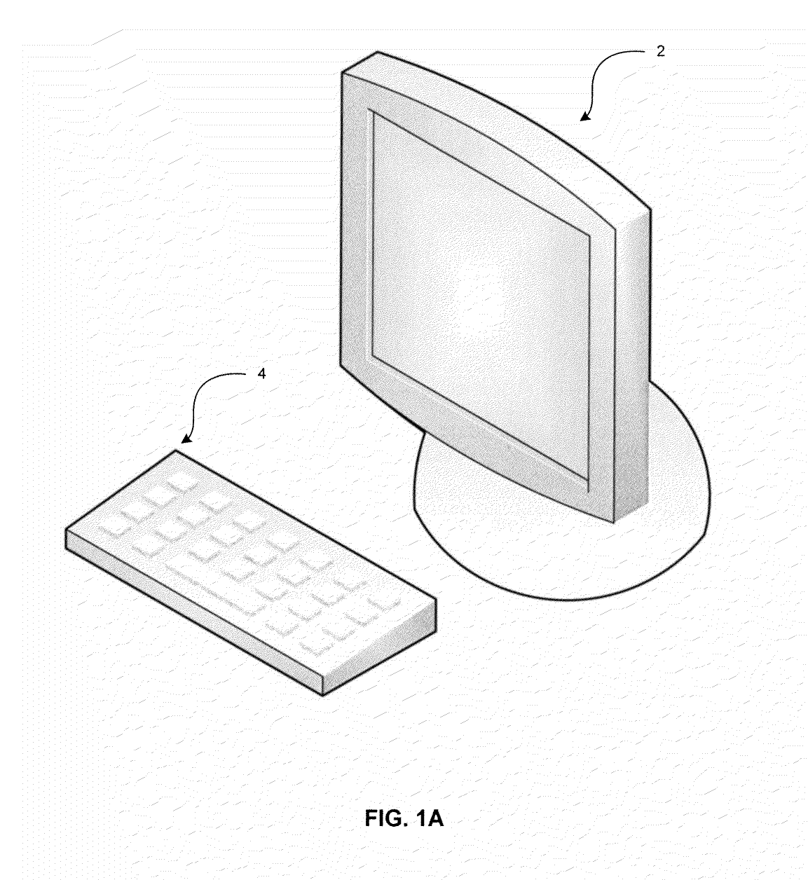

FIG. 1A illustrates an exemplary display 2 and input device 4. The display 2 may be integrated with or connected to a computer, laptop, mobile phone, tablet, television, or other electronic device. The input device 4 may be any one or more devices to permit a user to provide feedback, data, or information to the processor, especially in response to the images depicted on the display. For example, the input device 4 may be a keyboard, mouse, stylus, joystick, button, microphone, touchscreen, touchpad, or any combination thereof that may be connected to or integrated with the display 2.

FIG. 1B illustrates an exemplary user interface 6 for presenting information to a user. The user interface 6 may be shown on the display 2 of FIG. 1A. The user interface 6 is configured to present to a user different categories 8, 10 of information at a high level. For example, a first hierarchy of categories 8 may be displayed to a user. As shown, the categories of “LIVE”, “WORK”, and “PLAY” exemplify different aspects of a user's life. The user interface may also depict to a user a second hierarchy of categories 10, or subcategories, that further define aspects of the first hierarchy of categories 8. For example, the “WORK” category may be subdivided into “Services”, “Career”, “Investments”, and “Finance”.

Each category 8, 10 may be displayed with an image or symbol 12, written description 14, or a combination thereof alerting the user to the category. The user interface 6 is configured to receive an input from a user from the input device 4 to select one or more of the different categories 8, 10. The user interface may be configured to expand into an expanded category 10b from a selected category 10, while unselected categories may be configured to contract into a reduced category 10a to make space on the display 2 for the expanded category 10b. The expanded category 10b may be depicted in text, symbols, or figures similar to the categories 8, 10. The selected category may also be indicated by changing color, highlighting, background, font, or other attributes. Therefore, the selected category may be indicated or distinguished over the unselected categories. As shown in FIG. 1C, the expanded category 10b may be configured to display a third hierarchy of categories 16 that further subdivide the selected subcategory 10b. For example, the subcategory of “Investments” may be further subdivided into Stocks, Bonds, Real Estate, Mutual Funds, Precious Metals, and Collectables. Any of the displayed categories may have a selection for a master directory or other indicator to directly observe a full list of categories and/or subcategories.

The illustrated categories 8, 10 are shown and described as expandable and collapsible links, such that a user may activate a selected category by selecting the link through an input device communicating with the user interface. The categories may be displayed as pop-ups, drop down menus, call out windows, or other interface display mechanisms to display the expanded options of a selected category.

Exemplary first, second, and third hierarchy of categories may be as follows:

| First | Second | Third |
|---|---|---|
| Hierarchy | Hierarchy | Hierarchy |
| Category | Category | Category |
| LIVE | Social Media | Facebook ™ |
| | | Twitter ™ |
| | | MySpace ™ |
| | | MASTER |
| | | DIRECTORY |
| | Community | Skype ™ |
| | | Blogs |
| | | Social Clubs |
| | Personal | Health/Fitness |
| | | Music |
| | | Sports |
| | News | Local |
| | | Weather |
| | | Sports |
| WORK | Services | Home |
| | | Auto |
| | | Medical |
| | Career | LinkedIn |
| | | Education |
| | | Job Search |
| | Investments | Stocks |
| | | Bonds |
| | | Mutual Funds |
| | Finance | Banks |
| | | Checking |
| | | Advisors |
| PLAY | Shopping | Luxury |
| | | Phones |
| | | Gas |
| | Entertainment | Movies |
| | | Concerts |
| | | Sports |
| | Travel | Flights |
| | | Hotels |
| | | Cars |
| | Restaurants | Casual |
| | | Cuisine Type |
| | | Coffee & Tea |

The depicted categories may be dynamically or statically selected. If dynamically selected, the displayed categories may be based on an interest or volume of selections for any one or more categories by any one or more users. For example, the first hierarchy of categories may be static, such that the user interface always displays the same first hierarchy of categories. However, the second hierarchy of categories may be displayed based on the aggregate interest of all users for a given first hierarchy of category over a selected period of time. Therefore, the depicted second hierarchy of categories displayed under the first hierarchy of category is based on the rank of interest by aggregate users over the selected period of time. The displayed second hierarchy of categories may be refreshed at predetermined time intervals. For example, the second hierarchy of categories may display the top 4 categories selected under a given first hierarchy of category every 24 hours, week, month, or year. The selection of third hierarchy of category may be displayed based on the aggregate interest of a single user over a predetermined period of time. For example, the user interface may track the selection of a given user over a period of time and then display the most active categories from the previous predetermined amount of time. For example, a user's usage may be tracked over a day, 30 days, a month, a year, or any predetermined amount of time, and the top five most active categories associated with any second hierarchy of category is displayed as the third hierarchy of categories. Any combination of static and dynamic selection of any number of hierarchy layers of categories may be used. The dynamic selection may also be based on general access across the internet. For example, under “SOCIAL MEDIA” the presently most active top social media sites across the entire internet may be displayed to a user for selection, and not just limited to the activities of users of embodiments of the present system or a single user.

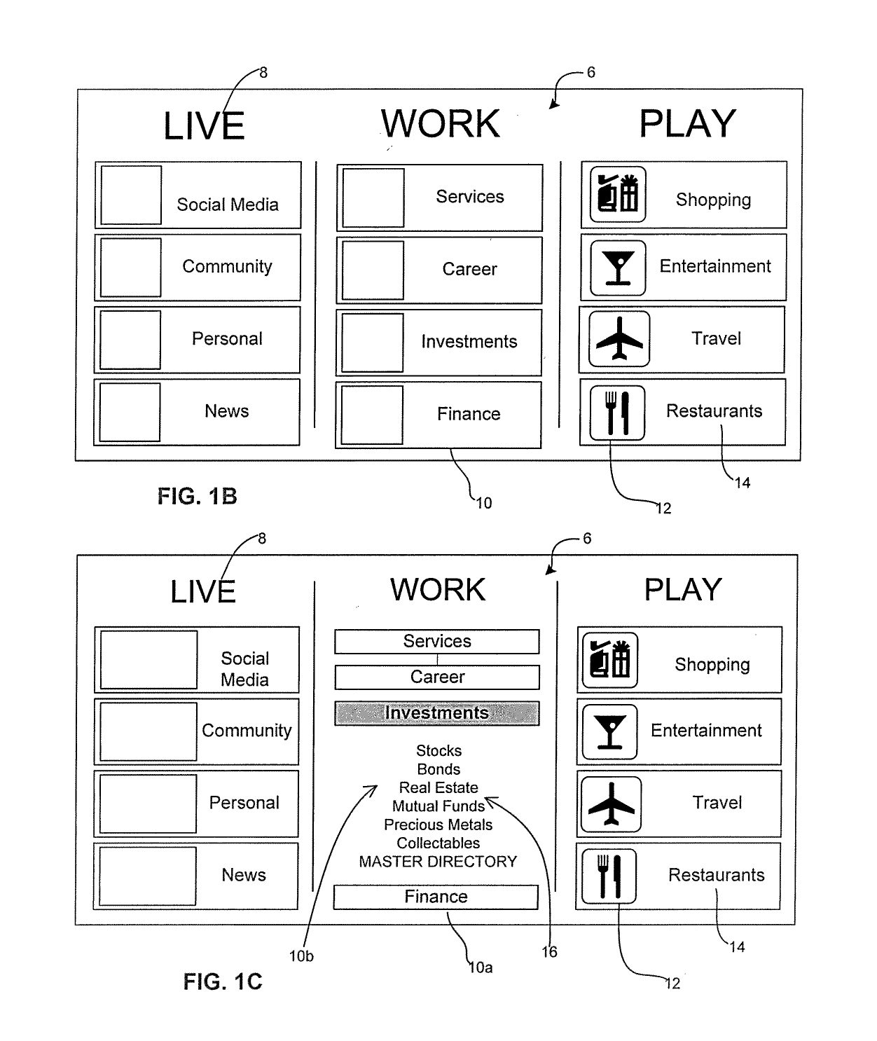

FIG. 2 illustrates an exemplary user interface in which the “MASTER DIRECTORY” of a selected subcategory, “Shopping” was received by a user through the one or more input devices. The user interface is configured to receive a selection of one or more categories through the input device as illustrated above with respect to FIG. 1. Once the hierarchy of categories is made, the user interface displays options related to the selected category. For example, if a master directory is selected for a given secondary category, such as shopping, the entire option list available to a user is displayed for review and selection in that shopping category. The master directory may therefore provide a full list of any one or more category hierarchy. As illustrated in FIG. 2, the master directory displays the available third hierarchy of categories for an associated selected second hierarchy category.

The master directory may also include a configurable input section 18 to permit a user to alter the display, orientation, ranking, or inclusion of further categories or additional results of the selected master directory. For example, as shown, a user may make a selection to reorder or display the categories of the shopping subcategory by brand, store, or product. Alternatively, or in addition thereto, the user may also select to include various retailers by category (i.e. on-line, resell, brick store, etc.) or actual retailer, such as Amazon, E-Bay, or Craigslist.

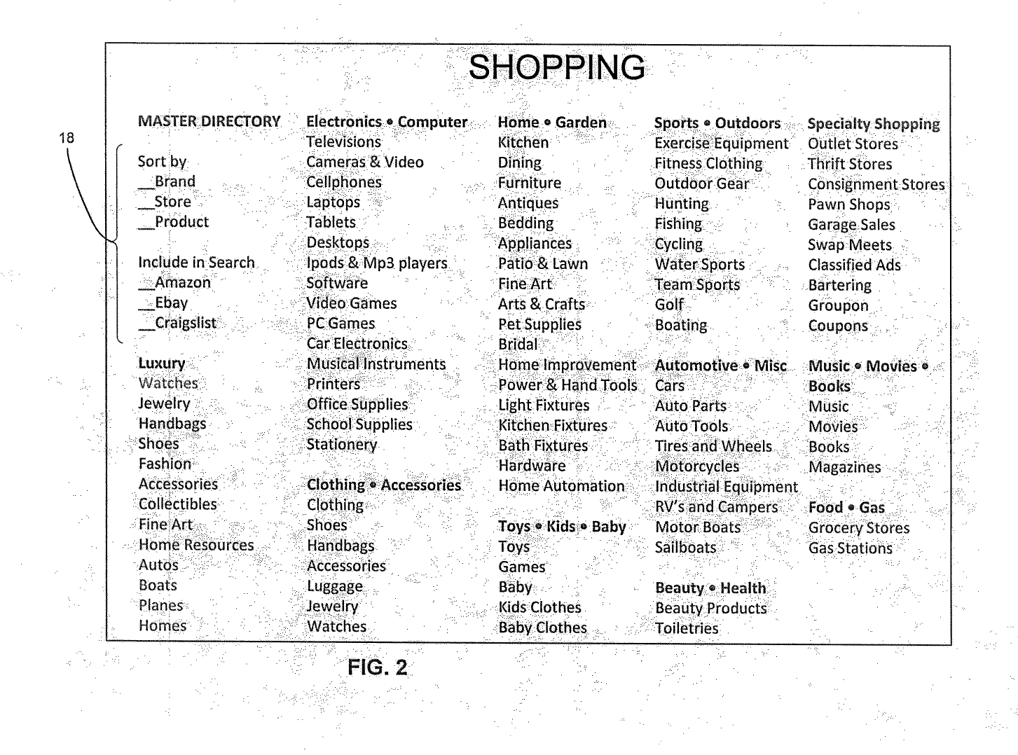

FIG. 3 illustrates an exemplary user interface display in which a selected category was made by a user. Once the user has navigated one or more selections of categories, the user interface may present a summary page to the user to permit the user to further refine a search for the selected final category. The user interface may be configured to display to the user one or more attributes to further refine the desired search. As illustrated, the user may select location radius, brands, price, and other attributes specific to the selected category. The user's selections may be indicated to the user by changing the font, color, or otherwise calling out the choice selections. As illustrated, the user's selections change color, increase in font, and become bolded. Any visual indicator of the user's selections may be made.

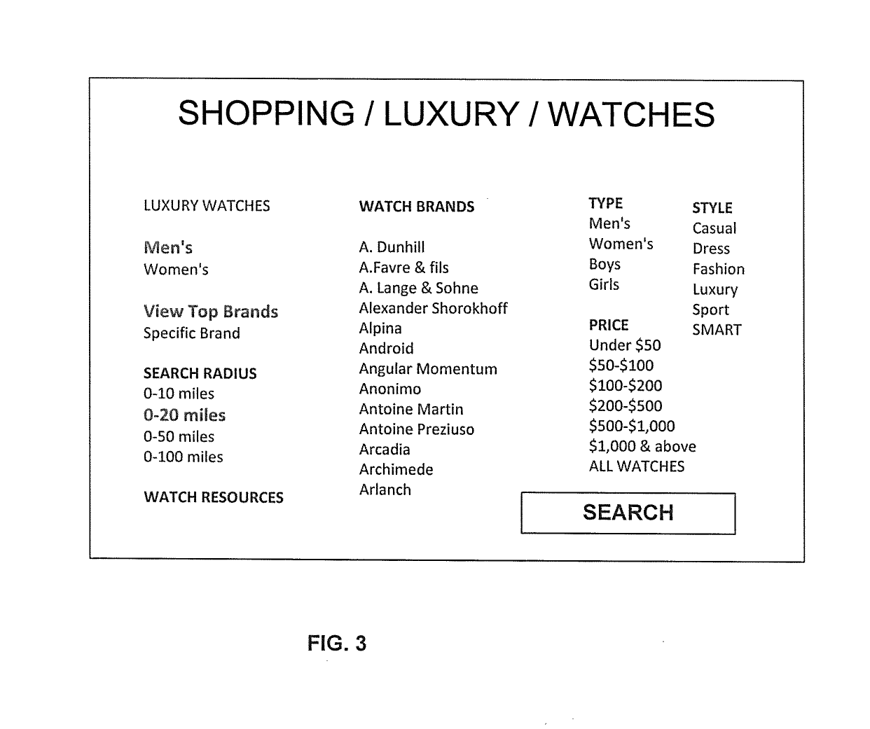

FIG. 4 illustrates an alternative presentation of the user interface for navigating to the same location of FIG. 3 from a series of expanded category selections from the user interface. Similar to FIG. 1B, the user interface displays a first and second hierarchy of categories. When a category is selected, the second hierarchy of categories associated with a first hierarchy category (i.e. a column as displayed), the second hierarchy categories either expands or contracts to provide a third hierarchy of categories, as explained above. FIG. 4 illustrates a selection of one of the third hierarchy of categories that provides a further selection of categories. As shown, the selection of “luxury” under “shopping” again expands the selection into a fourth hierarchy of categories, while removing from view the other previously displayed third hierarchy of categories associated with the selected second hierarchy category. If a user selects “watches” from this expanded options list, then the user may be directed to a new user interface display screen as illustrated in FIG. 3. Thus, a user may navigate to the same ultimate end search criteria selection through one or more paths or selections from screens of the user interface.

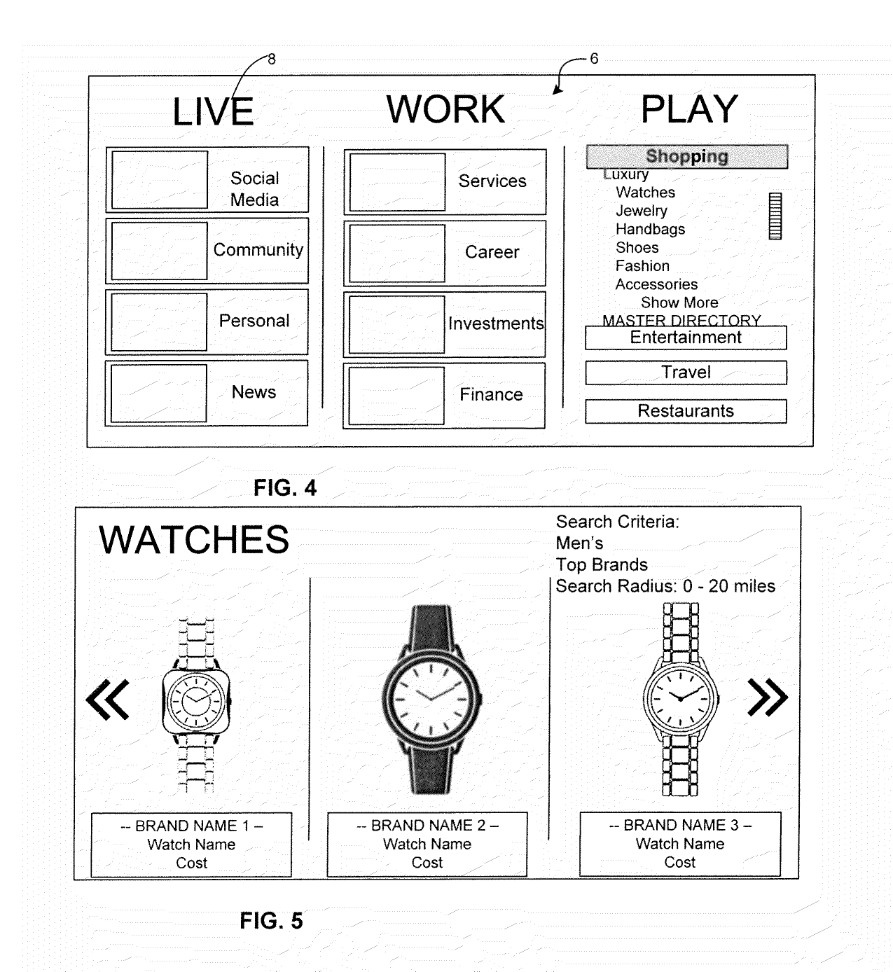

FIG. 5 illustrates a user interface search results screen in which the objects of the search are displayed to a user. The user interface may present information to the user regarding various results associated with the search criteria. For example, images, costs, specifications, etc. may be provided for a user to make one or more selections.

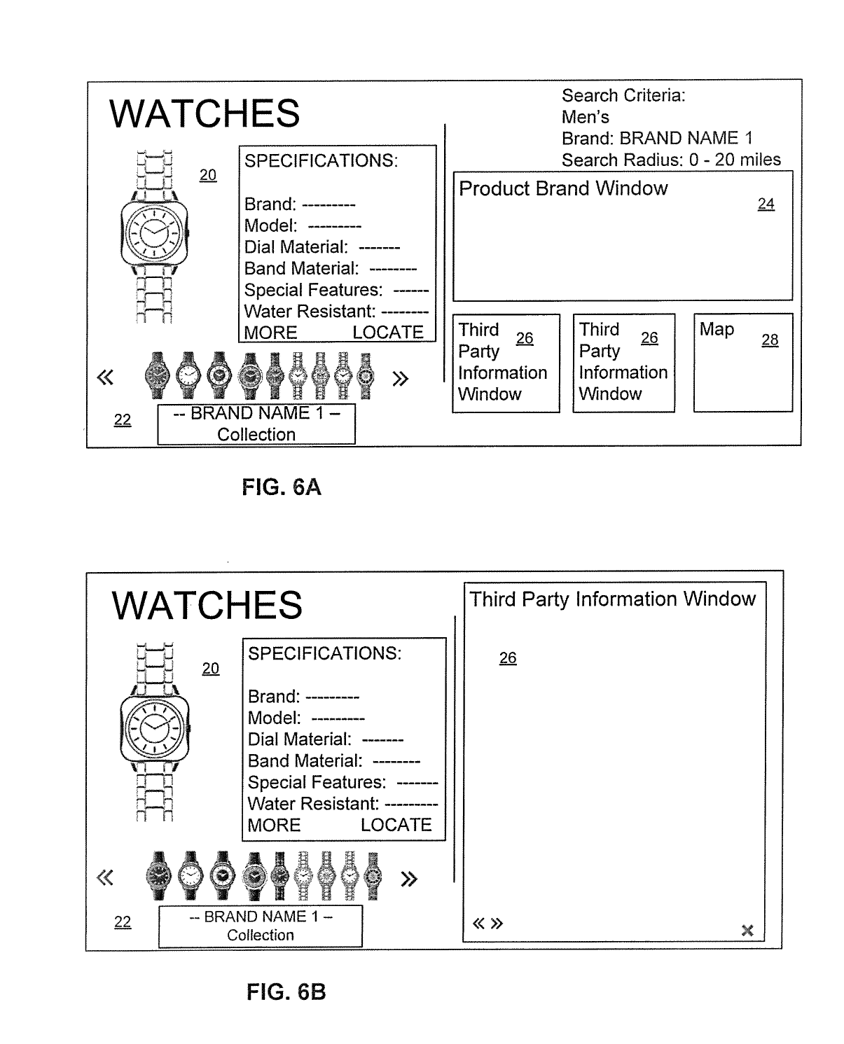

FIG. 6A illustrates a screen of the user interface in which the user has made a selection by providing input to the user interface of FIG. 5 through one or more input devices. The listed search criteria are updated based on the selection. For example, the search criteria includes the brand name and/or other categorical information of the selected product of the previous screen. As shown, a first portion 20 of the user interface window may present specifics of one or more objects meeting the parameters of the search criteria. A second portion 22 of the window may include other result objects meeting the search criteria, permitting the user to select or flip through specifications of different objects meeting the search criteria parameters. Thus, portions of the window interact dependently to provide specific information to the user based on input received by the user through one or more input devices.

The user interface may have multiple portlets for displaying information to the user simultaneously, which can be navigated independently. Other portions 24, 26, 28 may be present to display related information to the search criteria to the user for independent navigation. As shown, a first window 24 may be provided to the product or brand holder to provide specific information about the selected object. For example, if the search criteria are narrowed to a specific brand name, then the product brand window 24 may bring up the brand website. In the case of watches, if the user navigated to OMEGA™ watches, then the product brand window 24 may display the omega homepage, or to the specific brand page within the brand website. The user may then navigate through the window 24 to various links to obtain information from that website. Other windows may include, for example, information provided by independent third parties. These windows may use the search criteria to obtain additional information about the desired product through other providers. For example, a third party information window 26 may include a Wikipedia™ page that is appropriately selected to the topic of the specific brand or model selected by the user through the search criteria. Other third party information sources may include video sources, information sources, news, user comments and/or rankings, etc. The third party information window 26 may be selected based on one or more of the search criteria parameters. For example, if restaurants are searched, a third party information window may include a yelp search comprising the same or similar search criteria; if cell phones are searched, then a consumer comparison page may be provided, such as WhistleOut or PhoneArena. A window 26 may be provided for advertising competing products that may be bid or auctioned to other product providers seeking the attention of a user searching for competing products. A map 28 of locations selling the desired product may also be provided as a separate window.

The various windows 24, 26, 28 may be navigated independently, such that a user may select links and navigate through the respective windows to obtain additional desired information. Accordingly, the user interface is configured to permit independent display and manipulation of internet content through two or more windows, or portals on the same user interface page. The user interface is configured to receive input from a user through an input device and navigate a selection page through one of the two or more windows or portals without altering or changing the displayed content of one or more of the remaining windows or portals.

In an exemplary embodiment, two or more windows or portals of the same user interface page may be linked such that a selection within one window may automatically change the content displayed through another window. Accordingly, if search criteria are altered based on a selection of one or more objects from a first window, the displayed information of a second window may automatically be updated to coincide with the altered selections. For example, in FIG. 6B, if a user selects a given watch or brand within a first window 22, the displayed image and specifications of window 20 as well as the associated third party information window 26 may be updated to coincide with the selection made in the first window 22. If, for example, the third party information window 26 displays a Wikipedia or other informational page, the page may be updated to correspond to the brand and model of the watch selected by the user from the listed watches of window 22.

Therefore, in an exemplary embodiment, the user interface is configured to permit a user to provide search criteria by making one or more selections or inputs and displaying to the user in an easy and efficient manner one or more different windows corresponding to the provided search criteria from independent providers without having to reenter search criteria, coordinate or configure search terms or input fields, or otherwise having to duplicate search efforts among the various windows. The search results are provided on a single search page through one or more windows or portals that can be separately manipulated after the linked search is performed. For example, after the user has made a watch brand and model selection, and each of the pages 20, 22, and 26 are updated to correspond to the user's selection, links or other navigation mechanisms within the third party information window may be independently navigated to provide additional information of interest to the user without altering the display or results of the other windows 20 and 22. Accordingly, the one or more windows may be linked in a uni or bi-directional manner, such that manipulation of one window alters one, two, three, or more windows, such as a second window, but manipulation of the second window may (if bi-direction) or may not (if unidirectional) alter the first window.

As shown in FIG. 6B, select windows 26 may be manipulated so that as a window is navigated, it may be expanded to permit better viewing of its contents. For example, if one of the third party information windows 26 is selected by a user, the window may expand, replacing other interface windows, such as windows 24 and 28. Options may be provided to the user to close or reduce the expanded view of the window or navigate through pages displayed on the window. The user, for example, may click to close the window to reduce its size, or may select out of the window to reduce its size. The user interface may then display the different windows simultaneous for direct comparison of related information from different, unrelated sources.

FIG. 6C illustrates an exemplary user interface in which search results are displayed in a manner to directly compare the associated cost of the individual transaction. As shown, the map 28 window is expanded into map 30 to provide physical locations of stores containing the desired product. A comparison window 32 is provided that permits location details and corresponding pricing information for the desired product. The user interface is configured such that one or more purchasing criteria may be altered or manipulated so that the products from different retailers may be directly compared. For example, cost factors, such as shipping or travel, can be calculated into either cost or time of transaction. The user may identify key parameters important in the transaction. Accordingly, a user may appropriately evaluate and directly compare the displayed parameters on the user interface, which automatically take into consideration or calculate the key parameter according to other factors affecting that parameter.

The user interface may also permit comparison of on-line and off-line retailers in the same comparison window 32. For example, the map 30 may display brick and mortar physical store locations that a user may select to add to the comparison window 32. A menu of on-line retailers 34 may also be provided to permit the user to select which online retailers to include in the comparison. The comparison window 32 may then calculate pertinent parameters so that the products from the respective stores may be directly compared by the user. For example, the availability of a product may be verified, such that the immediacy of purchase may be presented to the user. For the remote locations, a time to purchase, such as driving times or shipping times may be incorporated into the displayed time to availability. The purchase price may similarly be adjusted to compensate for driving gas consumption, and/or shipping to directly compare the cost to the consumer to purchase a product.

Embodiments of the present invention are directed at a user interface for presenting diversified information from different sources to a user in a convenient and efficient format and manner. Embodiments of the user interface permit a user to provide search criteria through text box, selection of one or more categories, or other mechanisms. The user interface is configured to create one or more search strings or criteria compatible with other sites, presenting the user with the results of multiple locations while only having to go through the search criteria process once.

Embodiments of the user interface may be configured to present multiple windows or portals to a user to display the results from the different sites simultaneously to the user. The different windows may be linked such that a single search may be entered and propagated to multiple windows, permitting the user to see multiple results from unrelated sites, sources, or locations. The different windows may also be independent in that one or more windows may be navigated without altering one or more other windows. Therefore, once a search is run, the user may navigate sequential pages through one or more windows of the user interface page to explore information provided by the specific site, without affecting the results or display of the one or more other windows. For example, if an online encyclopedia (such as Wikipedia™) is searched and displayed in one of the windows, the user may select different embedded links or other navigational features originally displayed on the encyclopedia site after the initial search was run.

Embodiments of the user interface may be configured to dynamically select the sites displayed in one or more different windows or portals based on the history of one or more users of the user interface and/or the internet. For example, the user interface may track the usage of individual users or in the aggregate to display the most selected categories or sites within a given category. Alternatively, or in addition thereto, the user interface may receive information about the use or popularity of users of the interne generally and display the most trafficked sites. The user interface may be configured by a user to determine which attributes are static and which are dynamically chosen.

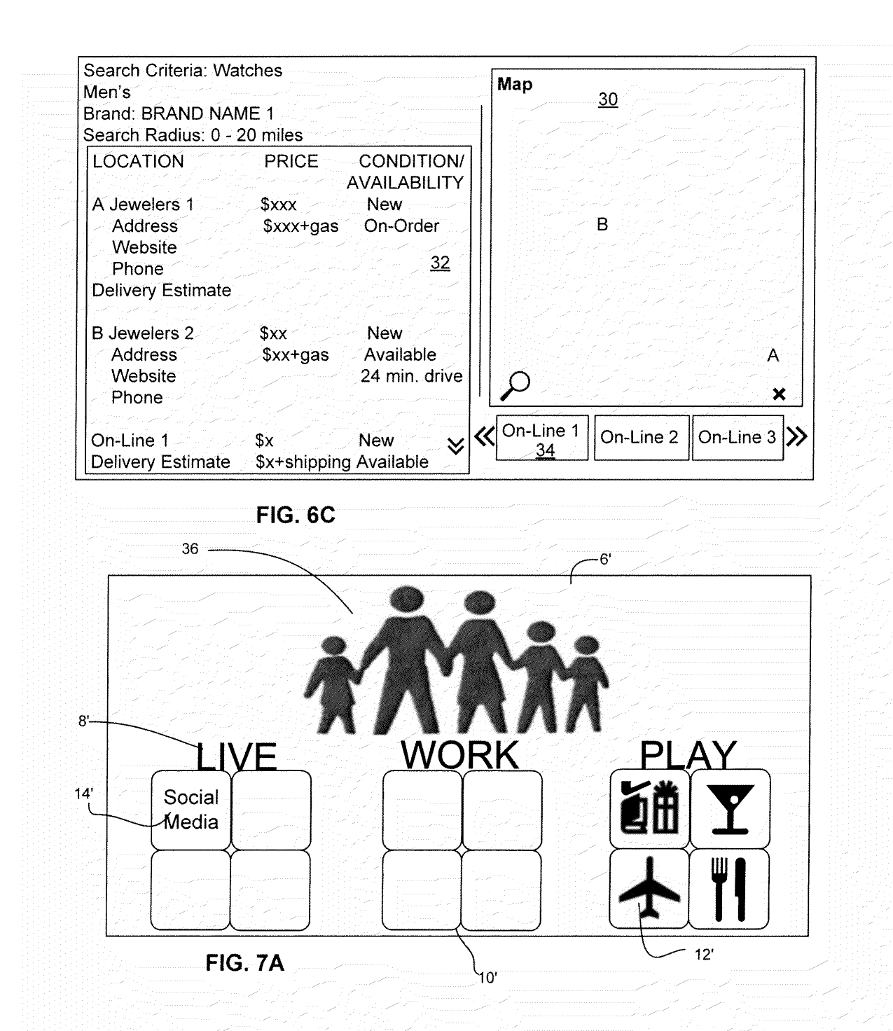

FIG. 7A illustrates an exemplary configurable user interface 6′. Embodiments of the user interface may be configured by a user. In an exemplary embodiment, a user may register an account that can save a user's preferences, configuration, usages, and other attributes to improve the user's experience and efficiency with the system. The configurable user interface 6′ may display the same as user interface 6 or may be configured to permit the user to customize the appearance. For example, a user may upload an image 36 to display on the configurable user interface 6′. The images 12′ or text 14′ associated with one or more categories 8′, 10′ may also be selected by the user. The user may also choose the combination of text or images to associate with a given category. The user may also choose to statically display given categories or permit dynamic selection of a category based on their usage, the aggregate usage of others on the system, or the general usage of internet traffic, or other criteria.

As seen in FIG. 7B, the user interface 6′ may be configured such that a selection of a primary category 10′ may display a list of subcategories 16′ through drop down menus, expanded menus, pop ups, different pages or windows, etc. The different hierarchy of categories may be chosen by the user, or selected by the system. For example, under shopping, the user may be prompted to enter or select preferred retail and on-line stores that will be priority searched for finding products through one or more searches. The user may also be prompted to enter home and/or work addresses so that the system can estimate travel times and costs associated with one or more search results. The system may compare travel time and costs to one or more locations saved for the user, such as home, work, or a frequented address when searching products. The system may then identify distance, cost, and associated time depending on the one or more locations associated with the user.

The user may also save one or more search criteria. The system may also track a location of the user, such as by GPS or ISP addressing on the user's device and alert a user when the search criteria are met in their vicinity. For example, a user may be looking for a particular watch brand and model but does not want to spend more than a maximum amount of money or drive more than a certain distance to find it. If the user is outside of their normal commute pattern or away from the locations associated with the user as entered by the user, the system may periodically update the search for the particular item. If a result is found meeting the particular requirements of the search, the user interface may send an alert to the user, such as a text, pop-up message, e-mail, etc. The alert preference may also be entered and saved to the user's account when creating preferences and/or when saving a particular search.

The system may also include a bidding platform. For example, when a user has saved search criteria indicating the desired product and associated price, the platform may send the respective information out to one or more retailers known or likely to have the desired product for sale to permit the retailers to create a custom offer for that individual. Essentially, the consumer may make a request or bid for a product to multiple retailers within or separately from the search system. If the retailers are interested in the customer or moving the product at the suggested price, then the retailer can engage the customer and provide further details associated with their offer or counter-offer based on the search criteria originally provided by the customer. The offer of the retailer may provide a direct to purchase option that permits the user to accept the terms and confirm purchase in a single act of confirmation. For example, the retailer may obtain information about the product and desired purchase price, the retailer may then accept the terms, and/or provide additional criteria such as shipping costs, estimated delivery times, pick up locations, offer expiration dates and times, etc. The system may then provide an alert to the user that a retailer has indicated a desire to transact on the provided search criteria, provide the offer and/or additional terms to the user, in which the user can confirm or decline to order based on the presented information. The user may also be provided an option to respond to the retailer if they want to amend any terms added or altered by the retailer. For example, the user may be offered a text option to write a note to the retailer about the order.

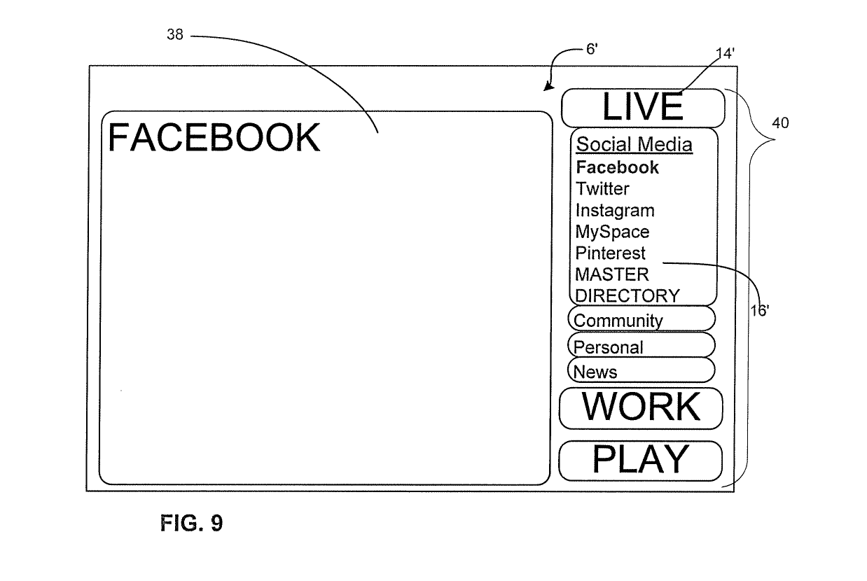

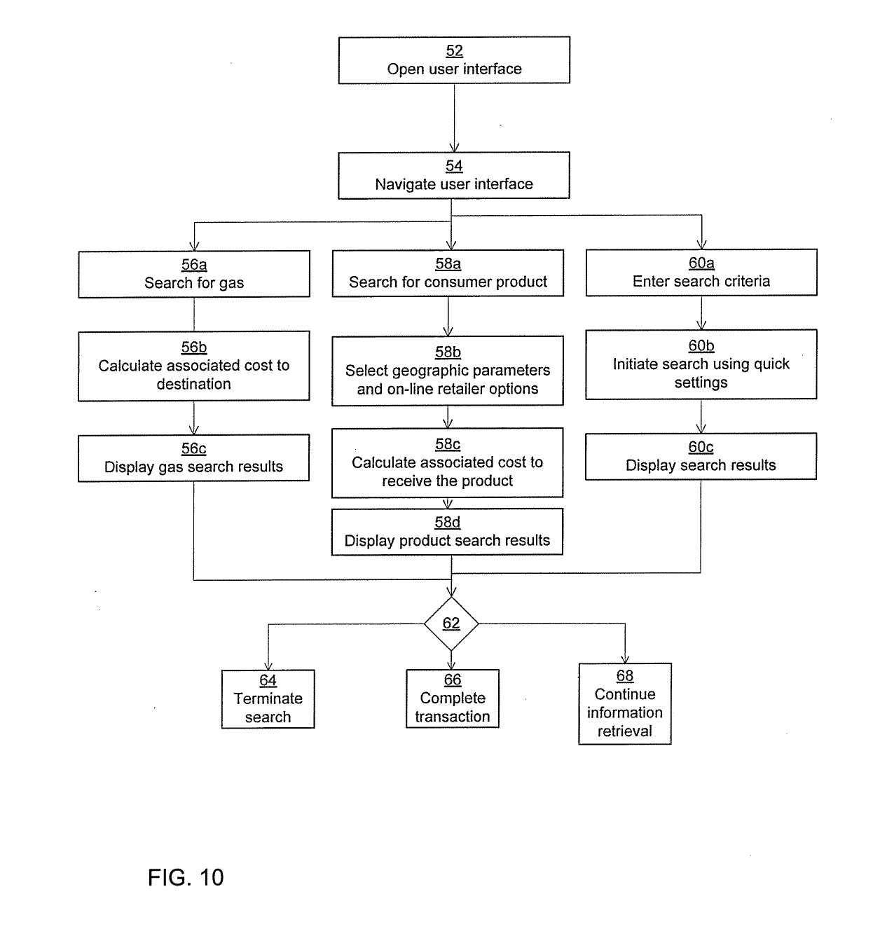

An exemplary bidding algorithm used to support the bidding platform is illustrated in FIG. 11. In an exemplary embodiment, a user opens the interface and performs a search as previously described in FIG. 10. At step 80, the user is then permitted to save the search according to embodiments described herein. When saving a search, the user may select to receive offers from vendors, retailers, sellers, or companies regarding their search criteria and/or related products. The user may make the selection in saving the search, in saving general preferences, etc. such that the user is preferably in control of what searches result in offers. Parameters limiting the received offers may also be saved by a user, such as identifying specific vendors, sellers, or companies; a specific scope of offers, such as those for the actual product searched for or competitor products, or related, accessory products; recurrence frequency, such that an offer may be updated for only a period of time (e.g. the user only wants offers within a certain expiration time), only at specific intervals such that they are not continuously inundated; or other parameters and/or preferences. At step 83, vendors, companies, or sellers may provide offers to users. The vendors, companies, or sellers may provide offers to specifically identified user or a group of users having given one or more search parameters. Vendors, companies, and/or sellers may provide offers generically at step 83 without being specifically notified at step 82. If a vendor, company, or seller provides general offers, these may be displayed within any of the search results, such as those described with respect to FIG. 10. These offers may be shown in addition to, in place of, or specially called out when displaying search results.

At step 82, the system may then permit vendors, companies, and/or sellers to be notified of the search. The notification may be by the system determining which vendors, companies, or sellers are relevant or potential candidates for fulfilling the search criteria and then alerting those entities of possible consumers. The system may also, or alternatively, permit entities to search on the saved search criteria to find a pool of consumers having search criteria desirable to the entity. Vendors, companies, or sellers may be notified in other ways as well.

The user may have created either an on-demand search (such as following steps 84-86) or a an automatic continual or periodic search (such as following steps 90-94). In either case, the search may be performed after the search criteria are saved. The user initiates a search at 84, while the system initiates the search at step 90. The user may be provided a choice to see offers provided by vendors, companies, and/or sellers, such as at step 85, or may be presented with the offers at steps 86, 92, or 94.

The offers may be displayed to a user in a number of options as provided by exemplary steps 86, 96, or 94. The offers may be integrated into search results, such that special offers replace or supplement items in a list of search results as described herein. For example, if an offer is provided by a retailer, the previously identified product as associated details from that retailer may be superseded or replaced with the details as provided in the offer. The system may distinguish offers from general products to alert a customer of the deal received by one or more retailers. Alternatively, or in addition, a user may receive special alerts or notices when special offers are made for products matching their search results. These alerts may be made through any format as generally described herein. For example, text, email, special application alert, etc. that either provides notice to the user and/or permits the user to navigate to a site or directly consummate the transaction and take advantage of the offer.

At step 96, the user may make a selection in response to the presented display options. The user may terminate the search at step 94 if nothing of interest is found, may complete a transaction at step 66 if the offer is satisfactory, or may continue the search at step 68. If the system determines that a transaction was consummated, then the system may request whether the user wants to maintain the search criteria, delete the search, or suspend the search. Accordingly, once a search is completed, the user may permanently or temporarily suspend the search and not receive associated results until desired.

The system may also be used to aggregate purchasing. Because the user information is stored along with a list of desired products, the system may locate consumers of similar criteria, including desired products, geographic location, etc. The system may then permit consumers to aggregate their purchasing requests and attempt bulk purchasing at discounted prices. For example, at step 98, the system may aggregate users that are then presented to one or more vendors/companies/sellers as a bulk purchaser. The vendor/company/seller may then offer a bulk price to the group to be accepted or rejected together or by a minimum threshold of users. A common pickup location and/or time may be coordinated through the system by permitting communication between users to facilitate the bulk purchasing nature as perceived by the vendor/company/seller.

In an exemplary embodiment, the system provides a bidding and/or negotiating platform for both consumers and retailers to identify products and associated desired prices, such that goods can be moved between individuals and retailers efficiently and conveniently. The bidding and/or negotiating platform may be integrated with the search features described herein or may be separate portals and/or windows for the consumer to review. For example, a user may enter in search criteria for a given product at a desired price. The system may save the respective criteria in a database to permit other user, including consumers and retailers to view the desired product and/or price to provide a direct to consumer interface or exchange between consumers and sellers.

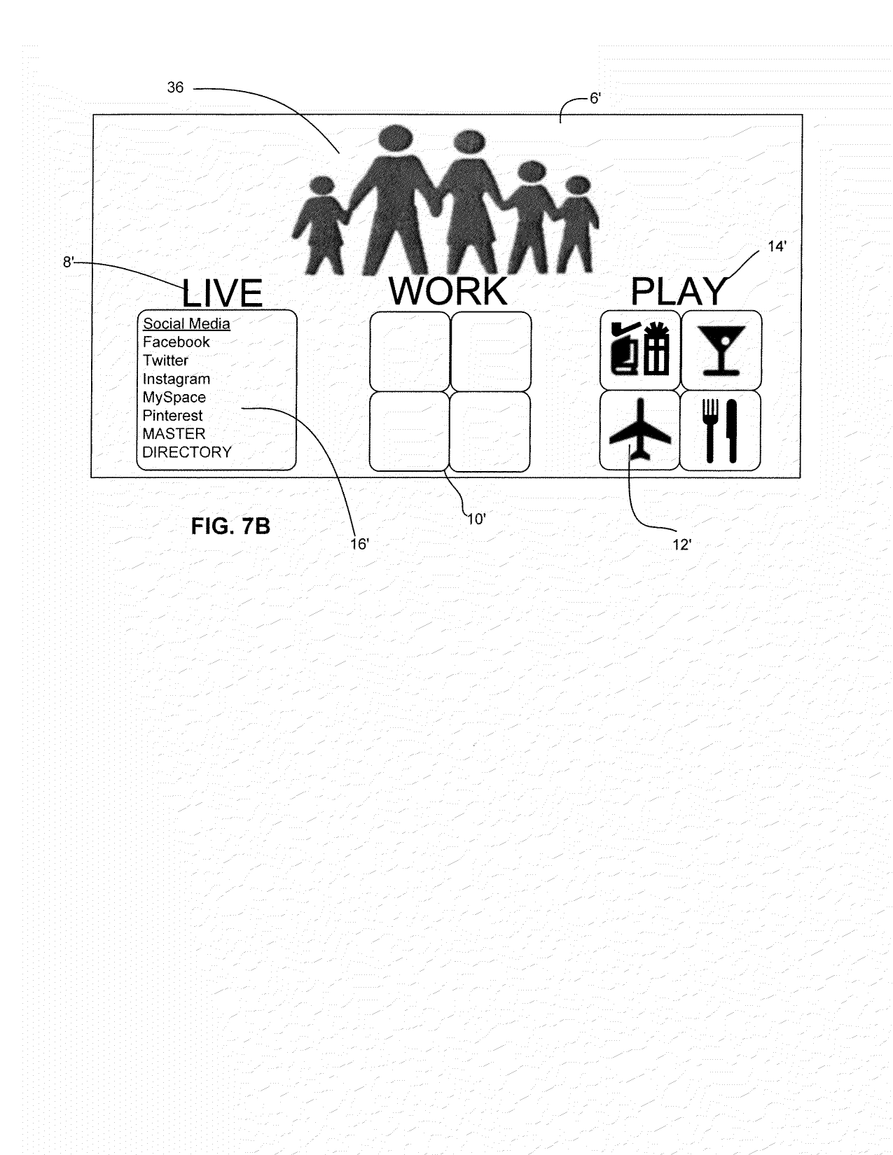

FIG. 8 illustrates an exemplary embodiment of a method comprising a recurring search. First, a user opens or navigates the user interface at step 70. At steps 72a-72c, exemplary search criteria may be entered as described herein, such as by sequential selection of one or more categories (step 72a) and/or returned search criteria or objects. Alternatively, search criteria may be entered on a user interface, such as at step 72c, through one or more text fields, radio buttons, buttons, drop downs, menu selections, category selections, etc. The search criteria may be separately entered and previously saved, such as at step 72b through the associated configuration preferences of a user. The search filters are entered on the user interface through the one or more input devices and sent to a server to be saved in a database associated with the user. At step 74, the search may be immediately run to find results and/or saved by the user. If run, the search criteria may also be saved to a user's history to be easily retrieved and rerun at a user's convenience. The user may save the search for an automated continual search or for a later on-call or on-demand search by the user. The system may then run the saved search at periodic intervals depending on the preference of the user, changes or updates in criteria, or at a configurable or predetermined interval period.

At step 78, the user may terminate the session with the associated search completed. At step 80, at some either undetermined or determined time later, the system and/or user may reinitiate the search according to the saved search criteria and/or updated search criteria. For example, the search criteria may include a time interface to automatically reinitiate the search and provide an alert or notice to the user with the search results. Alternatively, the user may perform the search on the same or a different device by launching the user interface and initiating the saved search without having to reenter the same search criteria.

At step 82, the user is then presented with final options after having reviewed the search results. For example, the user may terminate the search or close the present session at step 84. The search may be performed again at a later time, completely terminated, or deleted from the system. At step 86, the user may complete a transaction after having reviewed the search results and found a most desirable option, or at step 88, the user may continue to navigate the user interface to retrieve additional information before making a choice.

In an exemplary embodiment, the system may locate the user and update a location field of the user in the database, which may update the associated search criteria. The system may obtain a GPS signal from a mobile device, such as a smart phone, or may identify when a user is logged into the system and locate the origin of the IP address or other physical routing feature to generally or specifically locate the user. Once obtained, the associated location field of the user may be updated and the search parameters updated around the new location. Accordingly, a user may get an alert to the previously saved search criteria in the geographic region as updated by the user's present location.

The system may also comprise one or more mobile applications that can be downloaded, saved, and/or configured on a mobile device. A mobile device may include, for example, a phone, tablet, laptop, or other easily transportable electronic device that permits access to the internet.

In an exemplary embodiment, the mobile application may permit the customized user interface to provide alerts to the user. For example, if a user had a search saved through the customized user interface and the criteria of the search is met when the user is not presently navigating the user interface, the system may provide an alert through the mobile application on the mobile device. The search criteria may be met when the location of the user is accounted in the proximity analysis of a search, or if prices or websites are updated with new sales or stock information. The alert may present the results of the search through the mobile application to the user. The user may consummate the transaction directly through the mobile application, navigate to the respective site to obtain additional information or take the user to the user interface as described herein to further navigate the system.

In an exemplary embodiment, the mobile application may permit the user to provide inputs or information to the system. For example, the mobile application may permit voice or text commands to run a particular search that has already been saved to the system. In an exemplary embodiment, the user interface or customized user interface may be configured with a user's preference for a particular search. The search criteria may be saved associated with the particular search and/or user. The user may provide a verbal, text, button, or other input queue to initiate the search through the mobile application from the mobile electronic device. In an exemplary embodiment, the user may save associated with the search, for example, the verbal queue “run search”. Whenever, the user then wants to initiate the saved search, the user simply needs to launch/open or otherwise engage the mobile application and instruct the application with the verbal queue “run search”. The mobile application may communicate with the system to run the search and deliver the desired search results to the user. The mobile application may then present the user with one or more options to consummate a transaction, map the location, save or share results, etc.

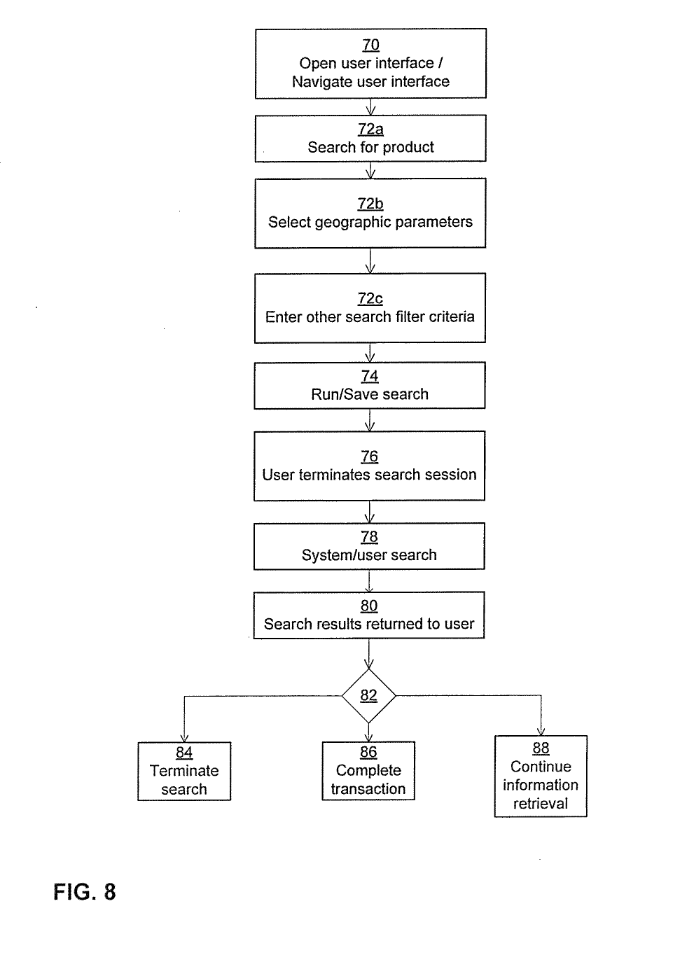

FIG. 9 illustrates an exemplary user interface 6′ in which one or more windows 38, 40 are displayed that permit a user to actively navigate through multiple websites simultaneously. For example, if a user had chosen “LIVE”, “Social Media”, and “Facebook” ™ as category selections, the system may open a window 38 within the page of the user interface 6′ to display the Facebook™ page of the individual user. The user accounts may be saved through the user interface and logged in upon each launch of the website through the window or may be saved through one or more services offered by the individual site and merely passed through the portal of the user interface 6′ window 38. A second window 40 may display other navigation options to the user to permit the user to traverse to different websites, within the same user interface 6′.

For example, the user may select twitter to check or view twitter feeds, in which the window 38 may display the twitter account of the user. The user may traverse back to their Facebook™ account by merely selecting Facebook™ again from the index window 40. The user interface 6′ may run previously opened links in the background to continually monitor activity on the respective sites. Therefore, the index window 40 may be configured to provide alerts to the user when certain activities occur on the respective links.

For example, if the user had previously visited Facebook™, but is currently playing a game under the “PLAY” category, the user interface may alert the user that a message had been posted to the user on Facebook™. The alert may merely be a highlighting or change of font of the associated category or presentation of a link in the index window to the location with the present activity. Pop-ups or other alert options may be similarly used to provide notice to a user. The user may then decide to leave their present location, such as the game, and navigate to the changed site. The system may automatically pause the game or second site while the user is observing the first site again.

Embodiments of the present invention permit a user to customize the internet to their usage and preferences. Sites from various origins and vendors may be displayed and navigated through a single page. Preferences from the user may be stored and used to select or search the various websites associated with the different origins and/or vendors.

In an exemplary embodiment, a user may save various attributes such as financial preferences, including the identity of stocks. When the user navigates to a financial category, the associated stock values saved under the user preferences may automatically be displayed. The user may be permitted to navigate to other websites associated with the companies corresponding to the saved stocks. If the user navigates to a news category, the news may be searched corresponding to information regarding the companies associated with the selected stocks. Therefore, the preferences of the user may inform the searches or displayed results of the user for one or more categories of the user interface.

Exemplary embodiments may be used to permit the user to navigate multiple unrelated websites while maintaining the websites simultaneously. Many conventional mobile devices permit a user to interface with a single application sequentially. Therefore, in order to check the activity of any application or review content from any one application or website, the user must close a previous application or website and open a new application or website. The transition from one location to another is time consuming and may be frustrating. In each case, the user loses the previously status of their experience with the application or website. Therefore, once the user reinitiates with an application or website, the user must each time traverse the start-up navigation, such as enter log-in information, select locations, etc. to resume their previous experience with a given application or website. Embodiments as described herein may be used to permit the user to navigate these various sites simultaneously, or without having to shut down an instance of the application.

FIG. 10 illustrates a flow chart of an exemplary application according to embodiments described herein.

First, at step 52, the user opens the user interface. The user may navigate to a website in order to view the user interface on a display of an electronic device. The user may log into the custom website to view the customer user interface according to embodiments described herein. Alternatively, the user may launch or initiate the mobile application to view a user interface according to embodiments described herein.

In an exemplary embodiment, the user interface may be an Hyper Text Markup Language (HTML) web page displayed on a browser. The browser is coupled through the internet or other network to a server that stores the web page for display to a user. The browser retrieves the web page and displays the user interface to the user.

At step 54, the user may then navigate the user interface to retrieve information, search, or otherwise navigate the internet through one or more windows of the user interface. The user may perform a number of exemplary functions within the user interface.

In a first exemplary function, the user may search for gas. The user may enter search criteria 56a for gas. The user may navigate one or more hierarchy category options to select “gas” from a shopping menu, or may enter in the search for gas directly, for example through a text search box. When entering the search, the user may enter additional search criteria, such as desired geographic location and proximity. These search criteria may be entered by the user and saved as default criteria for repetitive use, may be automatically suggested or limited by the user's application usage and/or from one or more other attributes associated with the user, such as GPS location data received about the user, personal information, such as work or home addresses, etc. entered by or retrieved about the user. The system then retrieves pricing information for the gas search given the search criteria, including, for example, geographic location and desired proximity. The system may comprise its own search engine to retrieve, index, and search the necessary information from the internet, and/or may use one or more other search engines or features to retrieve the desired information. The vendors may also enter or upload information to the server to provide a database of information to directly search and display to a user. Therefore, the system may retrieve information from any number of public or private sources. Permitting vendors to enter directly into the server provides local businesses an opportunity to appear on internet search results without separately maintaining a website. The smaller vendors may also directly compete with larger retailers if they cannot host the faster interne speeds that would permit a user to prefer to navigate a competitor's site.

The server then calculates one or more attributes associated with the gas to present to the user. The calculated attribute may include, for example, travel time and/or cost for purchase in which the location of the search origin (for example, an associated address of the user, a location attributed to the ISP of the user, and/or GPS location) and the destination is used. For example, the cost to purchase gas is not simply the price for gas retrieved from the search results. Instead, the cost to purchase includes the cost in gas and/or time to drive to and/or from the gas station. Therefore, the cost associated with each location is adjusted at step 56b to compensate for actual factors increasing the cost to the consumer. The compensation may be based on a number of factors. For example, the price of gas may be based on the gas price of the station navigated to or the price previously purchased. The system may also have information about the user's vehicle, such as make, model, and year or average gas consumption. If the vehicle criteria are provided, then the system may look up estimated average gas consumption. At each fill up, the user may also be prompted to enter the amount of gas obtained and the associated miles of travel to track an average gas consumption. The system may also estimate total miles driven based on the commuting habits of the user. For example, if the system is aware of the user's resident and business address, as well as the associate searches for one or more products, the system can estimate an approximate mileage between fill ups to determine an approximate gas consumption of the vehicle.

At step 56c, the search results are presented to the user. The results may be displayed on a map or listed for direct comparison. The display results may include the name of the station, address, directions, map location, cost of gas, adjusted cost of gas including the calculated value of step 56b, distance to destination, time to destination, other desired considerations associated with the purchase, or any combination thereof. The search results, therefore, permit a user to make a direct comparison of cost to the consumer in making purchasing decisions.

Third party information may also be displayed regarding the search criteria. For example, a trend of gas prices, or prediction of gas prices may be provided so that the consumer may estimate a desired purchasing time. This information may be displayed to the user simultaneously with the other search results and may be automatically informed by the search criteria entered by the user at steps 54 and 56a.

In a second exemplary function, the user may search for one or more products, such as groceries. At step 58a, the user enters in the desired grocery list. The user may keep a list of desired items and select the necessary items for purchase when necessary. At step 58b, the user may again select additional search criteria, including geographic parameters and/or on-line retailers to inform the search results. The search criteria are entered through the user interface and sent to the server. The server calculates an associated cost to receive the products at step 58c and displays the list to the user 58d. The user may select a limited number of desired locations and/or stops and a given parameter to optimize. For example, the user may select to make at most 3 stops and prefers one grocery retailer over another, but desires to receive the identified product list at the lowest possible price. The server may take the search criteria and present a shopping list to the user designating select items from different stores/locations. For example, the server may retrieve the associated merchandize cost from the local retailers. The system may account for travel time and cost to the associated merchants. The server may then minimize cost by grouping the number of products at different retailers with the lowest costs. The system may consider the additional travel cost in shopping over multiple locations in determining the best allocation of products from stores. The assessment may include on-line retailers, shipping, and receipt time as well. At step 56d, the system may thereafter display to the user a grouped shopping list by location, price, and desired route to shop for products between locations.

When comparing products, such as when performing the adjustment at step 56b, any number of factors can be considered. For example shipping costs, use taxes, sales taxes, handling fees, transaction fees, and other surcharges may be included such that a total and final costs may be provided to a customer for direct comparison of the same or similar product from different sources. Upgrade or additional charges may also be separately provided or indicated to a user, such that the user may be fully informed of the options associated with any purchase. For example, if expedited delivery options are available, the total cost or additional cost for the alternative feature, here the expedited delivery, may be separately provided to the user. Airline fees are a good example of additional fees that may be provided, such as for internet use, additional baggage, etc. The system may recognize when a disparity exists between the similarity in the products presented and alert the user. For example, in the airline context, if one airline includes one bag, but others charge an additional fee, the system may provide a notice in the cost results to indicate the disparity. In addition or alternatively, the system may prompt the user to provide additional information associated with the disparity. For example, the system may request the user specify an anticipated number of bags, such that the price of the respective airlines can be normalized to the actual or expected use of the consumer. If the user is only expected to have carryon luggage, then the system will compare costs at the lowest value without adding additional baggage fees, even if one airline already includes a bag. If additional bags are indicated, then the system can adjust the displayed totals for those airlines that require additional fees for the additional service. Accordingly, the user may again directly compare costs associated with the estimated specifications of their purchase, or may be alerted to differences in the displayed services provided between the provided quotes to indicate a difference in the products and services being purchased.

In a third exemplary function, at step 60a, a user may enter a desired search criteria. Along with the search criteria, the user may save a preference for launching the search quickly. For example, a vocal keyword or phrase may be associated with the search, a key term or phrase entered with the search, a series of quick key combinations, or other way to identify the desired search. The user saves the search, and the search criteria are saved in a database associated with the server. The search attributes correspond with the user, such that when a user initiates a session through the user interface, such as the mobile application, the user may initiate the search at step 60b using the quick search features. The search is performed at the server and the results provided to the user at step 60c.

After the respective search for function is completed, such as the exemplary functions 56, 58, or 60, the user may make a decision at step 62. The user may terminate the search at step 64 after having received the results. The user may continue to navigate the user interface to retrieve additional information regarding the search at step 68. Here, for example, the user may navigate the one or more windows within the user interface to retrieve additional information about the searched product through one or more third parties, or unrelated sites. The user may also make a selection from the displayed results and complete the transaction at step 62. The user may be connected through the user interface to the vendor's website to complete the transaction through their website. The user interface may also be configured to directly interact with the vendor website to provide payment information, secure the product, and provide confirmation of purchase to the user. Therefore, the user may quickly and securely consummate the transaction once the desired product and vendor are located.

To consummate the transaction, the system may store financial information of the consumer in an encrypted and secure format. The system may then communicate between the seller's system and the user's financial system (bank account, credit card, etc.) to transfer the appropriate funds to make and/or confirm payment for the transaction. The system may also update the seller's system or otherwise indicate to the seller and/or their system that the purchased product is no longer available inventory for purchase. The system may also provide a confirmation notice or alert to either or both the user and the retailer providing the details of the transaction.

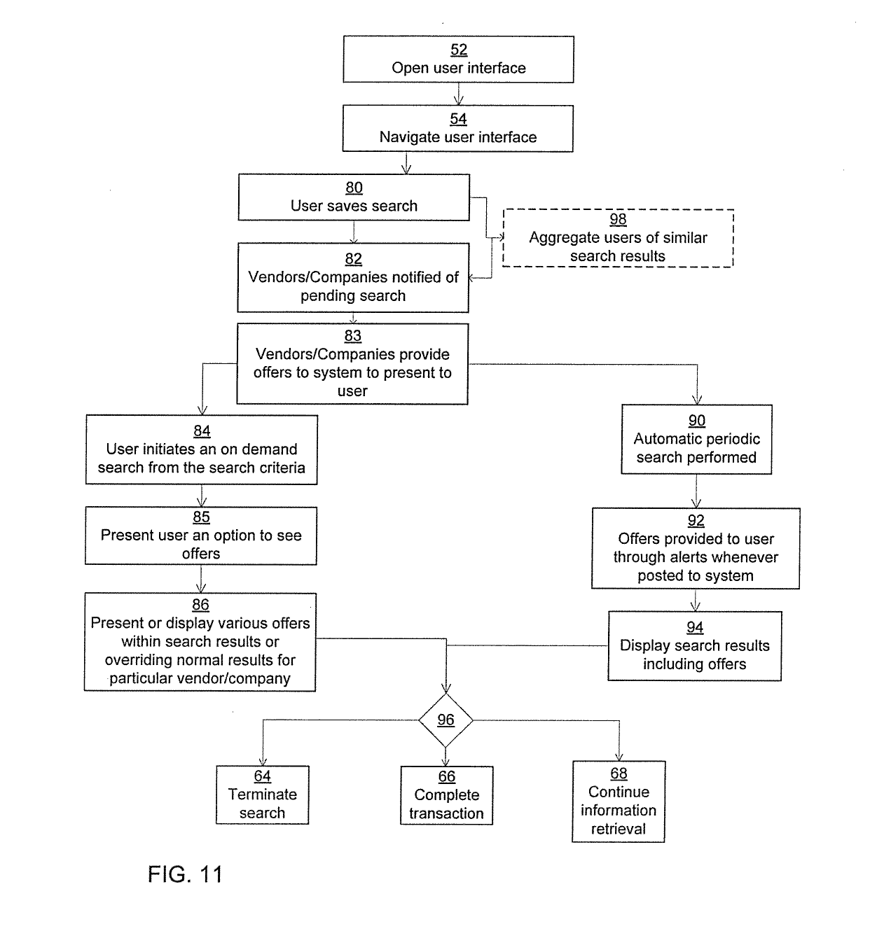

FIG. 12 illustrates an exemplary system in which embodiments of the present invention may be applied. Electronic devices 111 may be coupled to a network 101 having different communication protocols. Electronic devices 111 may include mobile devices such as cellular phones, smart phones 110A, tablets and/or personal digital assistant 111B, laptops 111C, etc. Electronic devices 111 may also include desktop computers 111D, or smart televisions. The electronic devices 111 communicate over hardwire or wireless communication such as WiFi, phone, cellular, bluetooth, etc. directly or indirectly to a network 101. Network 101 may be a public network such as the internet or a private network.

The network 101 couples the electronic devices 111 to one or more servers, 105A-105C. The servers 105 may communicate with one or more memories storing one or more databases 107A-107C. The servers 105, memory and/or databases 107 may contain information sought by a user, such as product descriptions, prices, locations. Individual retail stores may use one or more servers and associated memory and database to market and/or sell products to a consumer through dedicated websites or allow access for other web retailers to market and/or sell their products. Other information may include customer reviews, complaints, descriptions, comparisons, ratings, etc. The servers 105 may be used by one or more search engines, such that a search engine may periodically circulate interconnected servers through the network 101 and build indexes or references that store relevant information about the stored information and/or associated web pages located on those servers.

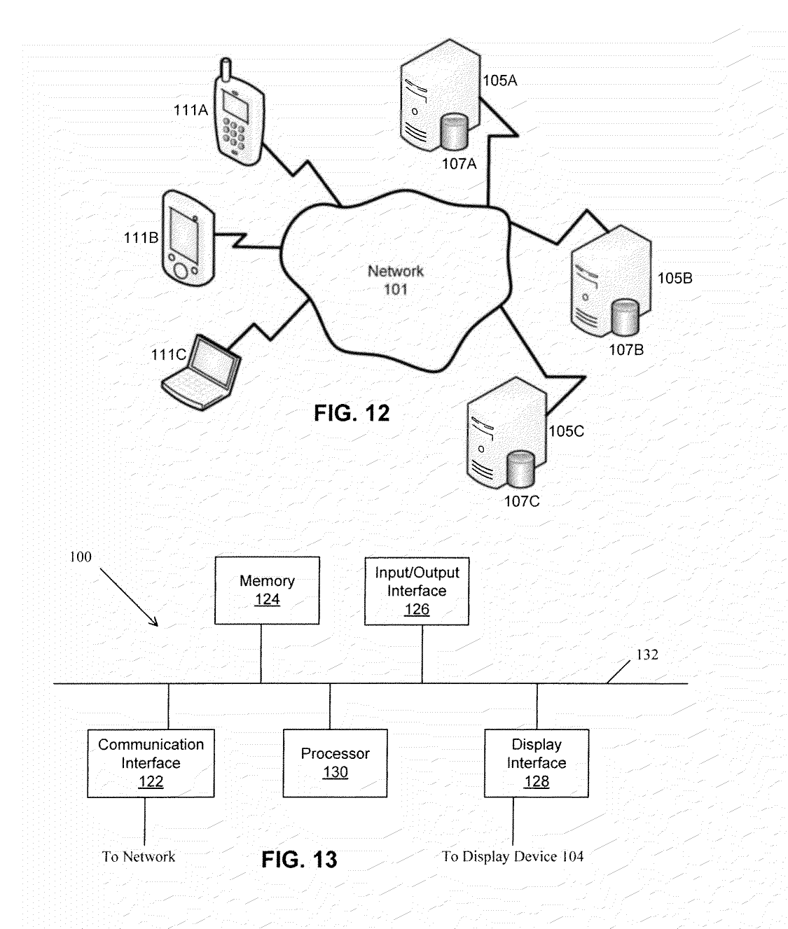

One or more of the servers 105A-105C may be used to store software configured to execute algorithms in accordance with embodiments described herein. A processor located within the electronic devices 111 or at the servers 105 may retrieve and execute the software to perform the exemplary functions. Software may be non-transitory machine readable code stored on one or more memories 124 executed by the processor 130 to perform one or more of the functions described herein. FIG. 13 illustrates exemplary internal components of the servers and/or electronic devices including hardware and software. A processing unit includes or is coupled to memory 124 and a processor 130. A plurality of software routines that may be stored on the memory 124 and executed by the processor 130 to perform the algorithms described herein. The processing unit may be based on a variety of commercially available platforms such as a personal computer or a workstation, or may be based on a custom platform that uses application-specific integrated circuits (ASICs) and other custom circuitry to carry out the techniques described herein. Additionally, the processing unit is coupled to one or more input/output (I/O) devices that enable a user to interface to the system. By way of example only, the processing unit may receive user inputs via a keyboard or any other data input device and may provide graphical displays to the user via a display 104 through the display interface 128, which may be, for example, a conventional video monitor or touch screen.

The illustrated components may be implemented using any suitable combination of hardware, software, and/or firmware. The system 100 may also include, according to one embodiment, a communication interface 122 for communicating with a network such as the Internet or World Wide Web, an intranet such as a local area network (LAN) or a wide area network (WAN), a public switched telephone network (PSTN), a cable television network (CATV), or any other network of communicating computerized devices.

Memory 124 may include for example, random access memory (RAM), hard drives, floppy diskettes, optical disks, CD-ROMs, DVD-ROMs, ROMs, RAMs, EPROMs, EEPROMs, magnetic or optical cards, and/or solid-state memory devices. The memory 124 may store an operating system (OS) (e.g., a Windows CE® OS or a Linux® OS), application program code, and various types of data. In one embodiment, the memory 124 stores information from or about the user, the search criteria or results, preferences, user history, or other attributes.

An input/output interface 126 may be provided for receiving commands from an input device, such as a mouse, keyboard, touch screen, or remote control, etc. The input/output interface 126 may detect, for example, a user pressing the user controls. The input/output interface 126 may also send data to an output device, such as a display, printer, or external storage device.

The system 100 may further include a display interface 128 for rendering graphical data, including the user interface, on the display device 104 and/or an external display device.

One or more processors 130 controls the operation of the system 100, including the other components described above, which may be in electrical communication with the processor 130 via a bus 132. The processor 130 may be embodied as a microprocessor, a microcontroller, a digital signal processor (DSP), or other device known in the art. The processor 130 may perform logical and arithmetic operations based on program code and data stored within the memory 124 or an external storage device.

Of course, FIG. 13 illustrates only one possible configuration of a system 100. An artisan will recognize that various other architectures and components may be provided.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but only by scope of the appended claims. Components as described herein may also be combined, integrated, separated, duplicated, repeated, removed, or otherwise recombined in any combination and stay within the scope of the present invention. Specifically, as used herein, when components or configurations are presented in a list as either “or” or “and”, the other is intended to be included or available unless clearly indicated otherwise. Methods and functions as described herein may also be performed in various order, concurrently, sequentially, subdivided, combined, or otherwise reconfigured and similarly stay within the scope of the invention.

The invention claimed is:

1. A user interface, comprising a web page displayed on a display having two or more portals, the two or more portals displaying content from independent sources and configured to receive input from a user to independently navigate the two or more portals.

2. The user interface of claim 1, wherein the user interface is configured to receive input from a user through a first portal of the web page, and the first portal and a second portal of the web page display first and second content respectively from independent sources related to the input through the first portal.

3. The user interface of claim 2, wherein the user interface is configured to receive additional input from a user through the second portal of the web page, and the second content of the second portal changes with respect to the additional input, while the first content displayed through the first portal remains unchanged.

4. The user interface of claim 1 wherein the user interface is configured to permit a user to provide search criteria by making one or more selections through the user interface and displaying to the user different windows on the two or more different portals corresponding to the provided search criteria from independent sources without having to reenter search criteria, coordinate or configure search terms or input fields, or otherwise having to duplicate search efforts within the two or more portals.

5. The user interface of claim 4, wherein results from the provided search criteria are displayed on a single search page through the two or more portals that can be separately manipulated after a search is performed.

6. An apparatus comprising:
a web-enabled user interface resident on a server that is displayed to a user on a device remote from the server, wherein components making up the user interface are implemented in electronic circuits, software coding, or any combination of the two, and where components implemented in software coding are stored in an executable format in a non-transitory machine-readable medium;
the web-enabled user interface configured to present web pages and templates to a browser application on a client machine to solicit preference and account criteria from a user, which is extracted from the web pages and templates and stored in an associated database; and
the web-enabled user interface configured to perform searches based on criteria entered by the user and the preferences and account criteria stored in the associated database and display information from independent and separate sources on a same web page.

7. The apparatus of claim 6, wherein the web-enabled user interface is configured to receive a single set of search criteria to display information from the independent and separate sources on two or more portals, such that the user does not have to enter separate search criteria to obtain information related to the search criteria from the independent and separate sources.

8. The apparatus of claim 7, wherein the displayed information on the two or more portals may be independently navigated after the search criteria is entered and the information displayed.

9. The apparatus of claim 6, wherein the web-enabled user interface is configured to display different products from independent and separate sources based on the search criteria and include purchasing information for the different products.

10. The apparatus of claim 9, the user interface is configured such that one or more purchasing information is altered so that the products from the independent and separate sources are directly compared.

11. The apparatus of claim 10, wherein the purchasing information comprises a cost of the different products, and the user interface is configured to adjust the cost of the different products to include the total cost to the user to acquire the product, such that the total cost includes cost factors of shipping or travel.

12. The apparatus of claim 10, wherein the user identifies key purchasing information important to a transaction and the altered purchasing information corresponds to the key purchasing information.

13. The apparatus of claim 12, wherein the key purchasing information is a total cost of acquiring a product.

14. The apparatus of claim 12, wherein the key purchasing information is a total time to receive a product.

15. An apparatus comprising:
a web-enabled user interface resident on a server that is displayed to a user on a device remote from the server, wherein components making up the user interface are implemented in electronic circuits, software coding, or any combination of the two, and where components implemented in software coding are stored in an executable format in a non-transitory machine-readable medium;
the web-enabled user interface configured to present web pages and templates to a browser application on a client machine to solicit preference and account criteria from a user, which is extracted from the web pages and templates and stored in an associated database; and
a mobile user interface executed separately from the web-enabled user interface configured to perform searches based on criteria entered by the user through the web-enabled user interface and the preferences and account criteria stored in the associated database.

16. The apparatus of claim 15, wherein the mobile user interface is configured to execute a search in response to a quick input associated with the criteria entered by the user through the web-enabled user interface.

17. The apparatus of claim 16, wherein the quick input is a voice command indicating a desired search to run.

18. The apparatus of claim 16, wherein the mobile user interface is configured to display a results list to the user, and receive inputs from the user in response to the displayed results.

19. The apparatus of claim 18, wherein the user can select a result from the displayed results list and complete a transaction.

20. The apparatus of claim 19, wherein the mobile user interface is configured to communicate with a seller to purchase a selected item from the displayed results list.
